(19) United States
(12) Patent Application Publication
(10) Pub. No.: US 2025/0039098 A1
(43) Pub. Date: Jan. 30, 2025

(54) OPTIMIZATION OF DELIVERY OF EXTENDED REALITY TRAFFIC OVER A WIRELESS LINK

(71) Applicant: MediaTek Singapore Pte. Ltd., Singapore (SG)

(72) Inventors: Abdellatif SALAH, Cambridge (GB); Pradeep JOSE, Cambridge (GB); Mukesh CHOUHAN, Cambridge (GB)

(21) Appl. No.: 18/717,215

(22) PCT Filed: Dec. 12, 2022
(86) PCT No.: PCT/CN2022/138378

§ 371 Date: Jun. 6, 2024

Related U.S. Application Data
(60) Provisional application No. 63/290,082, filed on Dec. 16, 2021.

(51) Int. Cl. H04L 47/2416; H04L 47/32; H04W 28/02; H04W 72/12

(52) U.S. Cl. CPC H04L 47/2416; H04L 47/32; H04W 28/0268; H04W 72/12

(57) ABSTRACT

Examples pertaining to optimization of delivery of extended reality (XR) traffic over a wireless link in mobile communications are described. An application implemented in a user equipment (UE) communicates with a network to transmit and receive one or more media units (MUs) or application data units (ADUs) of an extended reality (XR) traffic over a wireless link. The apparatus controls one or more aspects of the one or more MUs or ADUs to optimize delivery of the XR traffic.

### CROSS REFERENCE TO RELATED PATENT APPLICATION(S)

The present disclosure is part of a non-provisional application claiming the priority benefit of U.S. Patent Application No. 63/290,082, filed 16 Dec. 2021, the content of which herein being incorporated by reference in its entirety.

### TECHNICAL FIELD

The present disclosure is generally related to mobile communications and, more particularly, to optimization of delivery of extended reality (XR) traffic over a wireless link in mobile communications.

### BACKGROUND

Unless otherwise indicated herein, approaches described in this section are not prior art to the claims listed below and are not admitted as prior art by inclusion in this section.

In beyond-5^{th}-Generation (B5G) mobile communications, augmented reality (AR) and VR, cloud gaming traffic is expected to dominate network traffic over a 5^{th} Generation (5G) network. All media traffics have specific characteristics that could be useful to achieve better control and efficiency in transmission. Currently, 5^{th} Generation System (5GS) uses common quality of service (QoS) mechanisms to handle media services together with other data services without much differentiation and without taking full advantage of such characteristics. For example, packets belonging to the same video frame have dependency. An application needs to receive all the packets associated with a given video frame in order to decode the video frame correctly. That is, the loss of one packet would render other packets for the same video frame useless. Under current 3^{rd} Generation Partnership Project (3GPP) specification, a radio access network (RAN) would consider these packets as uncorrelated. On the other hand, packets of the same video stream but with different I/P frames or different positions in a group of pictures (GoP) have different contributions to user experience and thus should be handled differently. Accordingly, XR application awareness by network nodes (e.g., user equipment (UE) and base stations such as eNB and/or gNB) would improve user experience New Radio (NR) system capacity in supporting XR services, as well as reduce UE power consumption. 5GS network exposure to the application is required mainly to media services with stringent QoS requirements. Thus far, in 3GPP, a RAN has been service agnostic and all enhancements are not linked to specific services. However, this design, while very flexible, sets limitation on what a RAN can do to further optimize transmission of XR-related traffic (e.g., cloud gaming traffic).

Besides, QoS parameters specified in terms of Internet Protocol (IP) packets do not capture well application requirements. The concept of Media Units (Mus), Application Data Units (ADUs) and/or Packet Data Unit (PDU) sets, meaning set(s) of packets correlated with each other) have been introduced instead of classical packets/PDU units. That is, MU/ADU may be seen as the minimum granularity of information that a given application needs in order to start its processing. QoS requirements may thus be specified in terms of MUs and/or ADUs. An MU/ADU depends on the application as well as coder/decoder (codec). The size of an MU/ADU is determined by the video/audio codec or by end-to-end delay requirements. Moreover, an MU/ADU is segmented in a packetized media stream, and packets are re-assembled at the application layer of a receiver to reconstruct the MUs/ADUs. Incomplete MUs/ADUs are discarded. Thus, interaction between an Application Function (AF) and 5GS is needed for QoS coordination and synchronization between multiple QoS flows of a same UE. Exposure of 5GS network conditions to the application would be useful to enable fast codec rate adaptation.

In view of the above, there is a need for a solution of optimization of delivery of XR traffic over a wireless link in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving optimization of delivery of XR traffic over a wireless link in mobile communications.

In one aspect, a method may involve a processor of an apparatus implemented in a UE communicating with a network to transmit and receive one or more MUs or ADUs of an XR traffic over a wireless link. The method may also involve the processor controlling one or more aspects of the one or more MUs or ADUs to optimize delivery of the XR traffic.

In another aspect, a method may involve a processor of an apparatus implemented in a network node of a network communicating with a UE to transmit and receive one or more MUs or ADUs of an XR traffic over a wireless link. The method may also involve the processor controlling one or more aspects of the one or more MUs or ADUs to optimize delivery of the XR traffic.

In yet another aspect, an apparatus implementable in UE may include a transceiver and a processor coupled to the transceiver. The transceiver may be configured to communicate with a network over a wireless link. The processor may be configured to communicate, via the transceiver, with the network to transmit and receive one or more MUs or ADUs of an XR traffic over a wireless link. The processor may also be configured to control, via the transceiver, one or more aspects of the one or more MUs or ADUs to optimize delivery of the XR traffic.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to optimization of delivery of XR traffic over a wireless link in mobile communications. According to the present disclosure, a number of possible solutions may be implemented separately or jointly. That is, although these possible solutions may be described below separately, two or more of these possible solutions may be implemented in one combination or another.

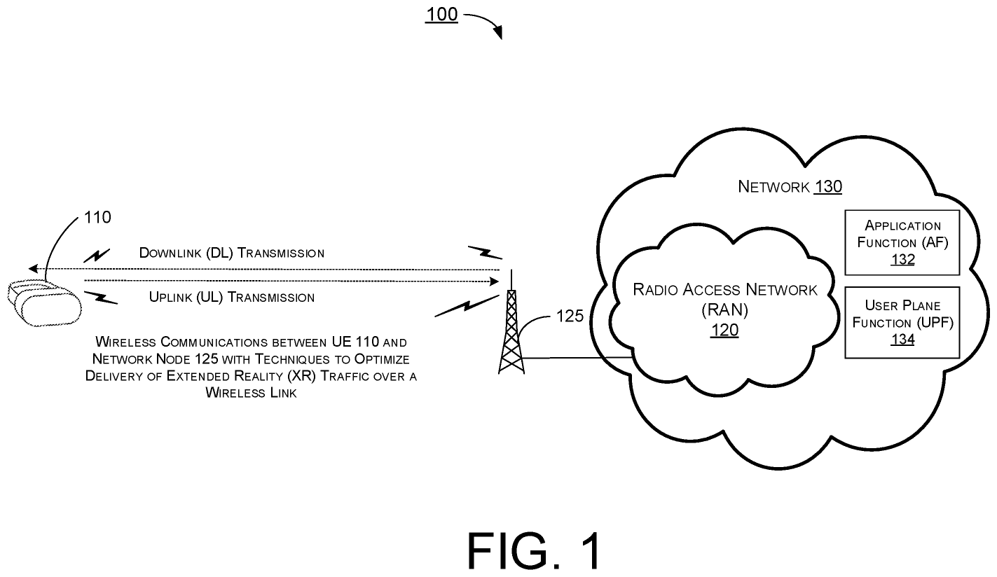

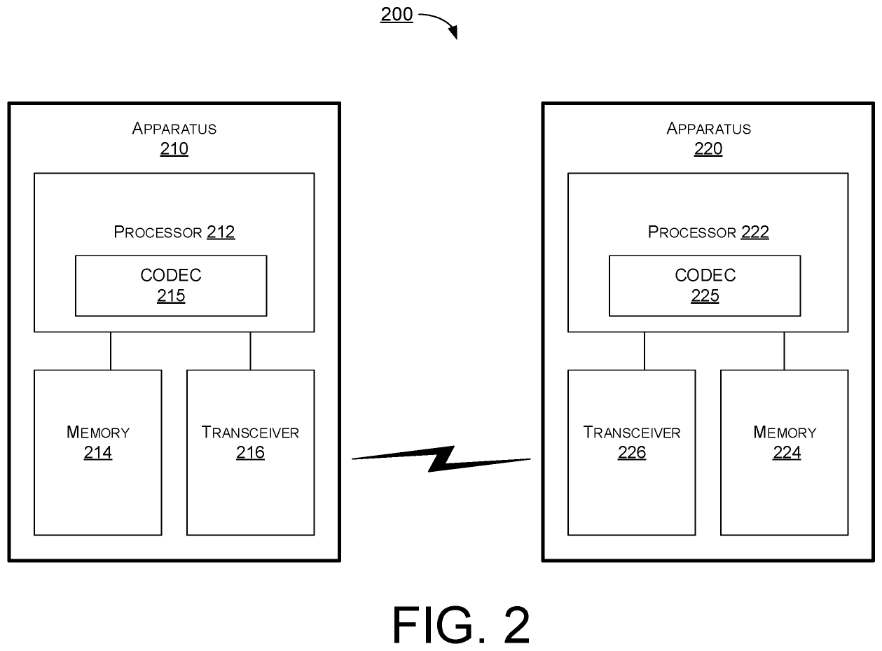

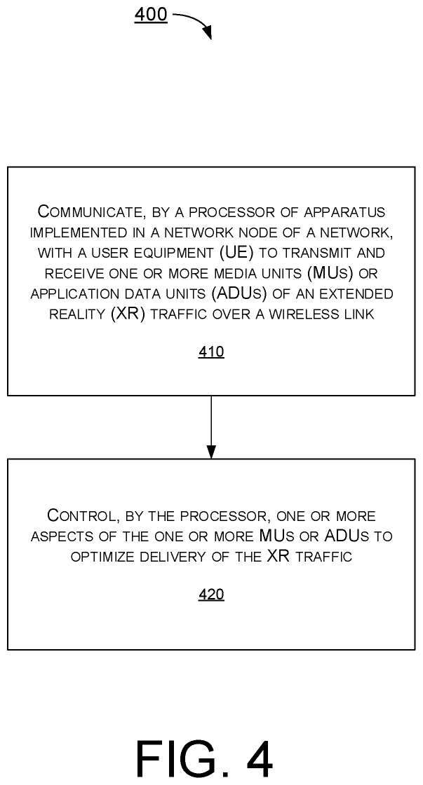

FIG. 1 illustrates an example network environment 100 in which various solutions and schemes in accordance with the present disclosure may be implemented. FIG. 2˜FIG. 4 illustrate examples of implementation of various proposed schemes in network environment 100 in accordance with the present disclosure. The following description of various proposed schemes is provided with reference to FIG. 1˜FIG. 4.

Referring to FIG. 1, network environment 100 may involve a UE 110 in wireless communication with a RAN 120. UE 110 may be in wireless communication with RAN 120 via a base station or network node 125 (e.g., an eNB, gNB or transmit-receive point (TRP)). RAN 120 may be a part of a network 130 which may include a 5G NR mobile network (having a terrestrial network (TN) and/or a non-terrestrial network (NTN)) and a 4^{th} Generation (4G) Evolved Packet System (EPS). Network 130 may also include certain functions such as, for example and without limitation, an application function (AF) 32 and a user plane function (UPF) 134, among other functions not listed herein in the interest of brevity. In network environment 100, UE 110 and network 130 (via network node 125 of RAN 120) may implement various schemes pertaining to optimization of delivery of XR traffic over a wireless link in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under a proposed scheme in accordance with the present disclosure with respect to MU/ADU level, a new QoS rule in an existing User Plane (UP) function may be defined or otherwise specified for MUs and/or ADUs. For instance, order indexing or sequence number may take place at the MU/ADU level. Moreover, a given function may carry out QoS mapping and order indexing.

Under the proposed scheme, RAN 120 may signal the dropping of an MU/ADU to the medium access control (MAC) layer, physical (PHY) layer, radio link control (RLC) layer, Packet Data Convergence Protocol (PDCP) layer, Service Data Adaptation Protocol (SDAP) layer and/or application layer at UE 110. For instance, a MU/ADU/PDU header may be utilized to signal the dropping of another MU/ADU. Alternatively, or additionally, a separate signaling may be used to signal the dropping of an MU/ADU. Alternatively, or additionally, UE 110 may replay or repeat a previous video frame. Alternatively, or additionally, UE 110 may advance its re-ordering window on reception of such information (of dropping of an MU/ADU). Under the proposed scheme, the MAC/PHY/RLC/PDCP/SDAP layer of UE 110 may signal the dropping of an MU/ADU back to the application layer of UE 110 (e.g., codec or another application). In some scenarios, the MAC/PHY/RLC/PDCP/SDAP layer of UE 110 may signal the dropping of an MU/ADU back to the application layer of UE 110 (e.g., codec or another application) if associated with a specific priority stream (e.g., I-frames). Additionally, the MAC/PHY/RLC/PDCP/SDAP layer of UE 110 may acknowledge (ACK) or negative-acknowledge (NACK) the transmission of an MU/ADU to the application layer of UE 110 or an XR server (of RAN 120). Moreover, the MAC/PHY/RLC/PDCP/SDAP layer of UE 110 may request or trigger retransmission of an MU/ADU from higher layers (e.g., application layer). The retransmission of an MU/ADU may be assigned a higher priority level compared to that of the original or initial transmission of the MU/ADU that was dropped. An out-of-order delivery of an MU/ADU may be tolerated or otherwise permissible to allow for MU/ADU retransmission at the PHY layer.

Furthermore, RAN 120 may be configured to drop PDU sets based on some criteria. PDU-set dropping may be configured in MAC and/or RLC and/or PDCP layer(s). Associated reordering windows at these protocol layers may be advanced when PDU-sets are dropped. In some implementations, a PDU-set (or a group of PDU-sets) may be dropped in case that X number of PDU packets failed to be transmitted or get lost during transmission within an associated Packet Delay Budget (PDB), e.g., X=1. Under the proposed scheme, PDU-set dropping may be configured for certain PDU-set types, priorities and/or traffic flows.

Under the proposed scheme, the application layer of UE 110 (or an Application Function (AF), User Plane Function (UPF), codec or an application server) may label MUs and/or ADUs. For instance, MUs/ADUs may be labeled with latency and/or reliability requirements or a priority index reflecting latency and/or reliability requirements. The labeling of MUs/ADUs may be useful as I-frames and/or P-frames belonging to the same video stream may have the same latency requirements but different reliability requirements. Moreover, P-frames may have the same latency requirements but different reliability requirements, as P-frames in the start of a GoP may be more important than P-frames at the end of the GoP (as the closer a P-frame is to an I-frame the more important the P-frame is).

Under another proposed scheme in accordance with the present disclosure with respect to UE assistance information, a network node (e.g., UE 110) may signal to another network node (e.g., network node 125 as a eNB, gNB or TRP) with information about an uplink (UL) transmission of the XR traffic to assist that network node in traffic scheduling. The assistance information may include, for example and without limitation, information on the types of UL traffics (e.g., pose/control, AR, haptic, sensors information, gaming commands and the like), priority of UL traffics and/or packet priorities, pose/control traffic periodicities, pose/control traffic payload, UL AR traffic periodicity and payload sizes (e.g., ADU/MU sizes), UL AR traffic jitter (if any), and/or UL AR traffic resolution (e.g., frame per second (fps)). Under the proposed scheme, a radio resource control (RRC) signaling may be used for the signaling of UE assistance information. Moreover, device (e.g., UE 110) assistance information may be enabled and/or disabled by a configuration from the network node (e.g., network node 125) via RRC signaling. Furthermore, device (e.g., UE 110) assistance information may be enabled and/or disabled per service, per application, and/or per stream.

Under yet another proposed scheme in accordance with the present disclosure with respect to RAN triggering of codec rate adaptation, RAN 120 may signal to a codec, through the application layer, information on network conditions. RAN 120 may also recommend, request or otherwise trigger codec adaptation. Under the proposed scheme, RAN 120 may signal to the codec, through the application layer, a preferred codec rate (e.g., quantization parameter (QP)) to adapt to the network conditions. Furthermore, RAN 120 may signal to the codec a current network load, distribution of signal-to-noise ratios (SNRs), distribution of delays and losses experienced by different streams, packets, and/or MUs/ADUs. In some implementations, RAN 120 may report a single aggregated metric reflecting RAN conditions, and this metric may be on a per-stream level or another level. In some implementations, RAN 120 may report a maximum threshold of data rate that can be supported by RAN 120 (e.g., per user, per flow, and so on). In some implementations, a sliding window may be used in RAN 120 to calculate the metric and/or threshold. In some implementations, a reporting periodicity may be configured to RAN 120 by the application layer of UE 110. In some implementations, RAN 120 may report when one or more specific limits are reached (e.g., predefined data rates). The codec may use this information received from RAN 120 to adaptatively estimate the maximum data rate that can be delivered to the device (e.g., UE 110) at a specific time. Under the proposed scheme, the codec/application server may acknowledge the reception of the signaling from RAN 120. Moreover, the codec/application server may signal to RAN 120 about when the adaptation is scheduled to start.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to optimization of delivery of XR traffic over a wireless link in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to optimization of delivery of XR traffic over a wireless link in mobile communications in accordance with various implementations of the present disclosure. For instance, processor 212 may include a codec 215 and processor 222 may include a codec 225, each configured to encode and decode the XR traffic under the various proposed schemes in accordance with the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125 or another network node implementing one or more network-side functionalities described above) of an application server side network (e.g., network 130 as a 5G/NR mobile network), is provided below.

Under various proposed schemes in accordance with the present disclosure pertaining to optimization of delivery of XR traffic over a wireless link in mobile communications, processor 212 of apparatus 210, implemented in or as UE 110, may communicate, via transceiver 216, with apparatus 220 implemented in or as network node 125 of a network (e.g., network 130) to transmit and receive one or more MUs or ADUs of an XR traffic over a wireless link. Moreover, processor 212 may control, via transceiver 216, one or more aspects of the one or more MUs or ADUs to optimize delivery of the XR traffic.

In some implementations, in controlling, processor 212 may apply a QoS rule that is defined for the one or more MUs or ADUs with order indexing or sequence numbering implemented at an MU or ADU level. In some implementations, in controlling, processor 212 may further utilize a function to carry out QoS mapping in applying the QoS rule.

In some implementations, in controlling, processor 212 may perform certain operations. For instance, processor 212 may receive a signaling from the network with information about dropping of one of the one or more MUs or ADUs. Additionally, in response to receiving the signaling, processor 212 may perform one or more of the following: (i) replaying or repeating a previous video frame; and (ii) advancing a re-ordering window on reception of the information. In some implementations, in receiving, processor 212 may receive the information in an MU header or an ADU header of at least one of the one or more MUs or ADUs. Alternatively, in receiving, processor 212 may receive a separate signaling other than the XR traffic.

In some implementations, in response to receiving the signaling, a MAC layer, PHY layer, RLC layer, PDCP layer or SDAP layer of apparatus 210 may performs one or more of the following: (i) informing an application layer of the UE about the dropping of the one of the one or more MUs or ADUs; (ii) transmitting an ACK or NACK regarding an MU or ADU transmission to the application layer or an XR server; and (iii) requesting or triggering an MU or ADU retransmission from a higher layer. In some implementations, retransmission of the dropped one of the one or more MUs or ADUs may have a higher priority level than that of an initial transmission of the dropped one of the one or more MUs or ADUs. Moreover, an out-of-order MU or ADU delivery may be permissible to allow for the retransmission at the PHY layer.

In some implementations, in communicating, processor 212 may communicate with the network (e.g., via apparatus 220) to transmit and receive the one or more MUs or ADUs with the one or more MUs or ADUs labeled to indicate different latency requirements, different reliability requirements, or both different latency and reliability requirements for I-frames or P-frames belonging to a same stream.

In some implementations, in communicating, processor 212 may signal UE assistance information to apparatus 220 as a network node of the network (e.g., network node 125 as an eNB, gNB or TRP) about an UL transmission of the XR traffic to assist the network node in traffic scheduling. In some implementations, the UE assistance information about the UP transmission of the XR traffic may include information on one or more of the following: (a) one or more types of UL traffics; (b) a priority of the UL traffic; (c) a periodicity of a pose or control traffic; (d) a payload size of the pose or control traffic; (e) a periodicity of an UL AR traffic; (f) a payload size of the UL AR traffic in terms of MUs or ADUs; (g) an UL AR traffic jitter; and (h) an UL AR traffic resolution. In some implementations, in signaling the UE assistance information, processor 212 may transmit the UE assistance information to the network node via a RRC signaling. In some implementations, processor 212 may further receive a configuration from the network that enables or disables the signaling of the UE assistance information. In some implementations, in receiving the configuration, processor 212 may receive the configuration via a RRC signaling. Alternatively, or additionally, the signaling of the UE assistance information may be enabled or disabled per service, per application or per stream.

In some implementations, in communicating, processor 212 may perform certain operations. For instance, processor 212 may receive a signaling from the network. Moreover, processor 212 may adapt a code rate used by codec 215 of processor 212 of apparatus 210 in processing the XR traffic responsive to receiving the signaling. In some implementations, in receiving the signaling, processor 212 may receive information on one or more of the following: (a) a network condition; (b) a preferred codec rate to adapt to the network condition; (c) a current network load; (d) a distribution of SNRs; (e) a distribution of delays and losses experienced by different streams, packets, MUs or ADUs; (f) a maximum threshold of data rate supported by the network per user or per flow; and (g) whether a predefined data rate is reached. In some implementations, the network condition may be indicated by a single aggregated metric per stream.

In some implementations, in adapting the code rate, processor 212 may perform certain operations. For instance, processor 212 may estimate a maximum data rate that is deliverable at a specific time. Additionally, processor 212 may adapt the estimated maximum data rate.

In some implementations, in controlling, processor 212 may further perform either or both of the following: (i) acknowledging receipt of the signaling to the network; and (ii) indicating to the network when adaptation of the code rate is scheduled to start.

Under various proposed schemes in accordance with the present disclosure pertaining to optimization of delivery of XR traffic over a wireless link in mobile communications, processor 222 of apparatus 220, implemented in or as network node 125 or another network node of RAN 120, may communicate, via transceiver 226, with apparatus 210 implemented in or as UE 110 to transmit and receive one or more MUs or ADUs of an XR traffic over a wireless link. Moreover, processor 222 may control, via transceiver 226, one or more aspects of the one or more MUs or ADUs to optimize delivery of the XR traffic.

In some implementations, in controlling, processor 222 may drop one or more PDU sets in an event that a predefined number of PDU packets failed in transmission within an associated packet delay budget. For instance, the dropping may be configured for one or more PDU-set types, one or more priorities, and/or one or more traffic flows. In some implementations, PDU-set dropping may be configured in at least one of a MAC layer, a RLC layer and a PDCP layer. Moreover, associated reordering windows at the MAC layer, the RLC layer and the PDCP layer may be advanced when the one or more PDU sets are dropped.

In some implementations, in controlling, processor 222 may perform certain operations. For instance, an application executed on an XR server of the network may adapt a code rate based on network signaling from processor 222. Additionally, processor 222 may signal, to an application executed by network 130, information on one or more of the following: (a) a network condition; (b) a preferred codec rate to adapt to the network condition; (c) a current network load; (d) a distribution of SNRs; (e) a distribution of delays and losses experienced by different streams, packets, MUs or ADUs; (f) a maximum threshold of data rate supported by the network per user or per flow; and (g) whether a predefined data rate is reached.

### Illustrative Processes

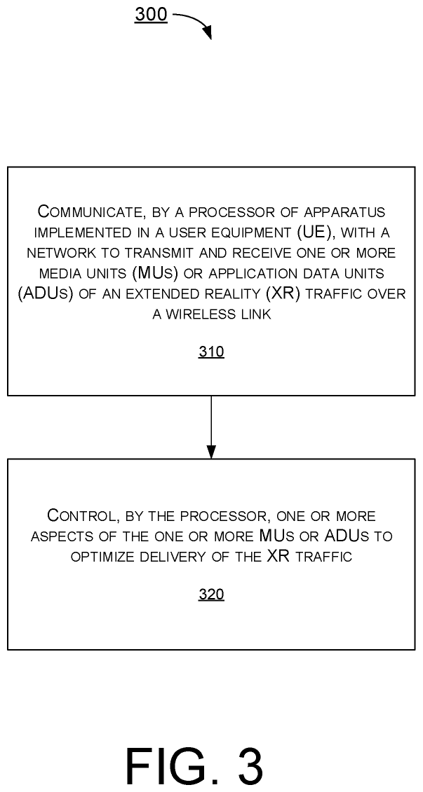

FIG. 3 illustrates an example process 300 in accordance with an implementation of the present disclosure. Process 300 may represent an aspect of implementing various proposed designs, concepts, schemes, systems and methods described above, whether partially or entirely, including those pertaining to those described above. More specifically, process 300 may represent an aspect of the proposed concepts and schemes pertaining to optimization of delivery of XR traffic over a wireless link in mobile communications. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125 or another network node implementing one or more network-side functionalities described above) of an application server side network (e.g., network 130). Process 300 may begin at block 310.

At 310, process 300 may involve processor 212 of apparatus 210, implemented in or as UE 110, communicating, via transceiver 216, with apparatus 220 implemented in or as network node 125 of a network (e.g., network 130) to transmit and receive one or more MUs or ADUs of an XR traffic over a wireless link. Process 300 may proceed from 310 to 320.

At 320, process 300 may involve processor 212 controlling, via transceiver 216, one or more aspects of the one or more MUs or ADUs to optimize delivery of the XR traffic.

In some implementations, in controlling, process 300 may involve processor 212 applying a QoS rule that is defined for the one or more MUs or ADUs with order indexing or sequence numbering implemented at an MU or ADU level. In some implementations, in controlling, process 300 may further involve processor 212 utilizing a function to carry out QoS mapping in applying the QoS rule.

In some implementations, in controlling, process 300 may involve processor 212 performing certain operations. For instance, process 300 may involve processor 212 receiving a signaling from the network with information about dropping of one of the one or more MUs or ADUs. Additionally, in response to receiving the signaling, process 300 may involve processor 212 performing one or more of the following: (i) replaying or repeating a previous video frame; and (ii) advancing a re-ordering window on reception of the information. In some implementations, in receiving, process 300 may involve processor 212 receiving the information in an MU header or an ADU header of at least one of the one or more MUs or ADUs. Alternatively, in receiving, process 300 may involve processor 212 receiving a separate signaling other than the XR traffic.

In some implementations, in response to receiving the signaling, a MAC layer, PHY layer, RLC layer, PDCP layer or SDAP layer of apparatus 210 may performs one or more of the following: (i) informing an application layer of the UE about the dropping of the one of the one or more MUs or ADUs; (ii) transmitting an ACK or NACK regarding an MU or ADU transmission to the application layer or an XR server; and (iii) requesting or triggering an MU or ADU retransmission from a higher layer. In some implementations, retransmission of the dropped one of the one or more MUs or ADUs may have a higher priority level than that of an initial transmission of the dropped one of the one or more MUs or ADUs. Moreover, an out-of-order MU or ADU delivery may be permissible to allow for the retransmission at the PHY layer.

In some implementations, in communicating, process 300 may involve processor 212 communicating with the network to transmit and receive the one or more MUs or ADUs with the one or more MUs or ADUs labeled to indicate different latency requirements, different reliability requirements, or both different latency and reliability requirements for I-frames or P-frames belonging to a same stream.

In some implementations, in communicating, process 300 may involve processor 212 signaling UE assistance information to a network node of the network about an UL transmission of the XR traffic to assist the network node in traffic scheduling. In some implementations, the UE assistance information about the UP transmission of the XR traffic may include information on one or more of the following: (a) one or more types of UL traffics; (b) a priority of the UL traffic; (c) a periodicity of a pose or control traffic; (d) a payload size of the pose or control traffic; (e) a periodicity of an UL AR traffic; (f) a payload size of the UL AR traffic in terms of MUs or ADUs; (g) an UL AR traffic jitter; and (h) an UL AR traffic resolution. In some implementations, in signaling the UE assistance information, process 300 may involve processor 212 transmitting the UE assistance information to the network node via a RRC signaling. In some implementations, process 300 may further involve processor 212 receiving a configuration from the network that enables or disables the signaling of the UE assistance information. In some implementations, in receiving the configuration, process 300 may involve processor 212 receiving the configuration via a RRC signaling. Alternatively, or additionally, the signaling of the UE assistance information may be enabled or disabled per service, per application or per stream.

In some implementations, in communicating, process 300 may involve processor 212 performing certain operations. For instance, process 300 may involve processor 212 receiving a signaling from the network. Moreover, process 300 may involve processor 212 adapting a code rate used by a codec of apparatus 210 in processing the XR traffic responsive to receiving the signaling. In some implementations, in receiving the signaling, process 300 may involve processor 212 receiving information on one or more of the following: (a) a network condition; (b) a preferred codec rate to adapt to the network condition; (c) a current network load; (d) a distribution of SNRs; (e) a distribution of delays and losses experienced by different streams, packets, MUs or ADUs; (f) a maximum threshold of data rate supported by the network per user or per flow; and (g) whether a predefined data rate is reached. In some implementations, the network condition may be indicated by a single aggregated metric per stream.

In some implementations, in adapting the code rate, process 300 may involve processor 212 performing certain operations. For instance, process 300 may involve processor 212 estimating a maximum data rate that is deliverable at a specific time. Additionally, process 300 may involve processor 212 adapting the estimated maximum data rate.

In some implementations, in controlling, process 300 may further involve processor 212 performing either or both of the following: (i) acknowledging receipt of the signaling to the network; and (ii) indicating to the network when adaptation of the code rate is scheduled to start.

FIG. 4 illustrates an example process 400 in accordance with an implementation of the present disclosure. Process 400 may represent an aspect of implementing various proposed designs, concepts, schemes, systems and methods described above, whether partially or entirely, including those pertaining to those described above. More specifically, process 400 may represent an aspect of the proposed concepts and schemes pertaining to optimization of delivery of XR traffic over a wireless link in mobile communications. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125 or another network node implementing one or more network-side functionalities described above) of an application server side network (e.g., network 130). Process 400 may begin at block 410.

At 410, process 400 may involve processor 222 of apparatus 220, implemented in or as network node 125 or another network node of RAN 120, communicating, via transceiver 226, with apparatus 210 implemented in or as UE 110 to transmit and receive one or more MUs or ADUs of an XR traffic over a wireless link. Process 400 may proceed from 410 to 420.

At 420, process 400 may involve processor 222 controlling, via transceiver 226, one or more aspects of the one or more MUs or ADUs to optimize delivery of the XR traffic.

In some implementations, in controlling, process 400 may involve processor 222 dropping one or more PDU sets in an event that a predefined number of PDU packets failed in transmission within an associated packet delay budget. For instance, the dropping may be configured for one or more PDU-set types, one or more priorities, and/or one or more traffic flows. In some implementations, PDU-set dropping may be configured in at least one of a MAC layer, a RLC layer and a PDCP layer. Moreover, associated reordering windows at the MAC layer, the RLC layer and the PDCP layer may be advanced when the one or more PDU sets are dropped.

In some implementations, in controlling, process 400 may involve processor 222 performing certain operations. For instance, process 400 may involve an application executed on an XR server of the network adapting a code rate based on network signaling from processor 222. Additionally, process 400 may involve processor 222 signaling, to an application executed by network 130, information on one or more of the following: (a) a network condition; (b) a preferred codec rate to adapt to the network condition; (c) a current network load; (d) a distribution of SNRs; (e) a distribution of delays and losses experienced by different streams, packets, MUs or ADUs; (f) a maximum threshold of data rate supported by the network per user or per flow; and (g) whether a predefined data rate is reached.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
communicating, by a processor of apparatus implemented in a user equipment (UE), with a network to transmit and receive one or more media units (MUs) or application data units (ADUs) of an extended reality (XR) traffic over a wireless link; and
controlling, by the processor, one or more aspects of the one or more MUs or ADUs to optimize delivery of the XR traffic.

2. The method of claim 1, wherein the controlling comprises applying a quality of service (QoS) rule that is defined for the one or more MUs or ADUs with order indexing or sequence numbering implemented at an MU or ADU level.

3. The method of claim 2, wherein the controlling further comprises utilizing a function to carry out QoS mapping in applying the QoS rule.

4. The method of claim 1, wherein the communicating comprises communicating with the network to transmit and receive the one or more MUs or ADUs with the one or more MUs or ADUs labeled to indicate different latency requirements, different reliability requirements, or both different latency and reliability requirements for I-frames or P-frames belonging to a same stream.

5. The method of claim 1, wherein the communicating comprises signaling UE assistance information to a network node of the network about an uplink (UL) transmission of the XR traffic to assist the network node in traffic scheduling.

6. The method of claim 5, wherein the UE assistance information about the UP transmission of the XR traffic comprises information on one or more of:
one or more types of UL traffics;
a priority of the UL traffic;
a periodicity of a pose or control traffic;
a payload size of the pose or control traffic;
a periodicity of an UL augmented reality (AR) traffic;
a payload size of the UL AR traffic in terms of MUs or ADUs;
an UL AR traffic jitter; and
an UL AR traffic resolution.

7. The method of claim 5, wherein the signaling of the UE assistance information comprises transmitting the UE assistance information to the network node via a radio resource control (RRC) signaling.

8. The method of claim 5, further comprising:
receiving a configuration from the network that enables or disables the signaling of the UE assistance information.

9. The method of claim 8, wherein the receiving of the configuration comprises receiving the configuration via a radio resource control (RRC) signaling.

10. The method of claim 8, wherein the signaling of the UE assistance information is enabled or disabled per service, per application or per stream.

11. The method of claim 1, wherein the controlling comprises:
receiving a signaling from the network; and
adapting a code rate used by a coder/decoder (codec) of the UE in processing the XR traffic responsive to receiving the signaling.

12. The method of claim 11, wherein the receiving of the signaling comprises receiving information on one or more of:
a network condition;
a preferred codec rate to adapt to the network condition;
a current network load;
a distribution of signal-to-noise ratios (SNRs);
a distribution of delays and losses experienced by different streams, packets, MUs or ADUs; and
a maximum threshold of data rate supported by the network per user or per flow,
whether a predefined data rate is reached.

13. The method of claim 12, wherein the network condition is indicated by a single aggregated metric per stream.

14. The method of claim 11, wherein the adapting of the code rate comprises:
estimating a maximum data rate that is deliverable at a specific time; and
adapting the estimated maximum data rate.

15. The method of claim 11, wherein the controlling further comprises performing either or both of:
acknowledging receipt of the signaling to the network; and
indicating to the network when adaptation of the code rate is scheduled to start.

16. A method, comprising:
communicating, by a processor of apparatus implemented in a network node of a network, with a user equipment (UE) to transmit and receive one or more media units (MUs) or application data units (ADUs) of an extended reality (XR) traffic over a wireless link; and
controlling, by the processor, one or more aspects of the one or more MUs or ADUs to optimize delivery of the XR traffic.

17. The method of claim 16, wherein the controlling comprises dropping one or more Packet Data Unit (PDU) sets in an event that a predefined number of PDU packets failed in transmission within an associated packet delay budget, and wherein the dropping is configured for one or more PDU-set types, one or more priorities, or one or more traffic flows.

18. The method of claim 17, wherein PDU-set dropping is configured in at least one of a medium access control (MAC) layer, a radio link control (RLC) layer and a Packet Data Convergence Protocol (PDCP) layer, and wherein associated reordering windows at the MAC layer, the RLC layer and the PDCP layer are advanced when the one or more PDU sets are dropped.

19. The method of claim 16, wherein the controlling comprises:
adapting a code rate used by an application executed on an XR server of the network based on network signaling; and
signaling, to the application, information on one or more of:
a network condition;
a preferred codec rate to adapt to the network condition;
a current network load;
a distribution of signal-to-noise ratios (SNRs);
a distribution of delays and losses experienced by different streams, packets, MUs or ADUs; and
a maximum threshold of data rate supported by the network per user or per flow,
whether a predefined data rate is reached.

20. An apparatus implementable in a user equipment (UE), comprising:
a transceiver configured to communicate with a network over a wireless link; and
a processor coupled to the transceiver and configured to perform operations comprising:
communicating, via the transceiver, with the network to transmit and receive one or more media units (MUs) or application data units (ADUs) of an extended reality (XR) traffic over the wireless link; and
controlling, via the transceiver, one or more aspects of the one or more MUs or ADUs to optimize delivery of the XR traffic.
